(19) United States
(12) Patent Application Publication
(10) Pub. No.: US 2004/0146194 A1
(43) Pub. Date: Jul. 29, 2004

(54) Image matching method, image matching apparatus, and wafer processor

(76) Inventors: Masayoshi Ichikawa, Tokyo (JP); Kazuyuki Maruo, Tokyo (JP)

Correspondence Address: Mr. Jonathan P. Osha, Rosenthal & Osha L.L.P., One Houston Center, 1221 McKinney Street, Suite 2800, Houston, TX, 77010, US

(21) Appl. No.: 10/626,815

(22) Filed: Jul. 24, 2003

Related U.S. Application Data
(63) Continuation of application No. PCT/JP02/01430, filed on Feb. 19, 2002.

(30) Foreign Application Priority Data
Feb. 20, 2001 (JP) 2001-43235

(51) Int. Cl. G06K 9/00; G06K 9/62

(52) U.S. Cl. 382/145; 382/209

(57) ABSTRACT

A wafer processor includes a matching apparatus for detecting an approximate region approximated to a predetermined template image from an input image. The matching apparatus includes input signal generating means for generating a first input signal and a second input signal representing pixel values of an input image projected, respectively, on a first axis and a second axis, first axis/first section detecting means for detecting a first axis/first section including an approximate region in the first axis direction from an input image, second axis/first section detecting means for detecting the second axis/first section including an approximate region in the second axis direction, and candidate region signal generating means for generating a third input signal representing the pixel value of the candidate region image projected on the first axis in the input image specified by the first axis/first section and the second axis/first section projected on the first axis, and first axis/second section detecting means for detecting the first axis/second section including an approximate region in the first axis direction.

The present application is a continuation application of PCT/JP02/01430 filed on Feb. 19, 2002, claiming priority from a Japanese patent application No. 2001-043235 filed on February 20, 22001, the contents of which are incorporated herein by reference.

### BACKGROUND OF THE INVENTION

1. Field of the Invention

The present invention relates to an image matching method, an image matching apparatus, and a wafer processor. More particularly, the present invention relates to the image matching method, an image matching apparatus, and a wafer processor for matching images rapidly.

2. Description of Related Art

In order to expose a circuit pattern to a wafer such as a semiconductor substrates a mark is provided on a predetermined position on the wafer to align the wafer accurately, and the position of the mark on the wafer is detected. Then, a predetermined pattern is exposed on the wafer by referring the position of the detected mark. In order to detect the position of the mark on the wafer, image matching technology is used. In the conventional image matching technology, the image including the mark on the wafer is acquired as an input image, and the pixel value of the input image is compared with the pixel value of a template image two dimensionally.

However, in order to detect the position of the mark of the input image, since a normalized cross-correlation value has to be calculated using a complicated formula, the calculation has to be repeated many times if the pixel value of the input image is compared with the pixel value of the template image two dimensionally. Therefore, it takes enormous amount of times to detect the position of the mark on the wafer, and it has been difficult to reduce the time of the wafer exposure processing.

### SUMMARY OF THE INVENTION

Therefore, it is an object of the present invention to provide an image matching method, an image matching apparatus, and a wafer processor which can solve the foregoing problem. The above and other objects can be achieved by combinations described in the independent claims. The dependent claims define further advantageous and exemplary combinations of the present invention.

In order to solve the aforesaid problem, according to the first aspect of the present invention, there is provided an image matching method of detecting an approximate region approximated to a predetermined template image from an input image. The image matching method includes steps of: generating a first input signal and a second input signal representing a pixel value of the input image respectively projected on a first axis and a second axis substantially perpendicular to the first axis; detecting a first axis/first section including a region corresponding to the approximate region in a direction of the first axis based on a first template signal representing a pixel value of the template image projected on the first axis, and also based on the first input signal; detecting a second axis/first section including a region corresponding to the approximate region in a direction of the second axis based on a second template signal representing a pixel value of the template image projected on the second axis, and also based on the second input signal; generating a third input signal representing a pixel value of a candidate region image in the input image specified by the first axis/first section and the second axis/first section projected on the first axis; and detecting a first axis/second section including a region corresponding to the approximate region in the direction of the first axis based on the first template signal and the third input signal.

The candidate region signal generating step may include a step of generating a fourth input signal representing a pixel value of the candidate region image projected on the second axis, and the image matching method may further include a step of detecting a second axis/second section including a region corresponding to the approximate region in the direction of the second axis based on the second template signal and the fourth input signal.

Moreover, the image matching method may further include a step of generating the first template signal and the second template signal by respectively projecting the pixel value of the template image on the first axis and the second axis of the template image.

The first axis/first section detection step may include steps of: extracting an edge region where a level of the pixel value in the first template signal changes a lot; and extracting an edge region where the level of the pixel value in the first input signal changes a lot, and the first axis/first section detection step may detect the first axis/first section based on the signal value of the edge region in the first template signal, and the signal value of the edge region in the first input signal, and the second axis/first section detection step may include steps of: extracting an edge region where a level of the pixel value in the second template signal changes a lot; and extracting an edge region where the level of the pixel value in the second input signal changes a lot, and the second axis/first section detection step may detect the second axis/first section based on the signal value of the edge region in the second template signal, and the signal value of the edge region in the second input signal.

The first template edge region extraction step may include steps of differentiating a signal value of the first template signal, and extracting a coordinate, at which the absolute value of the once differentiated value is greater than a predetermined value, as the edge region, the first input signal edge region extraction step may include steps of differentiating a signal value of the first input signal, and extracting a coordinate, at which the absolute value of the once differentiated value is greater than a predetermined value, as the edge region, the second template edge region extraction step may include steps of differentiating a signal value of the second template signal, and extracting a coordinate, at which the absolute value of the once differentiated value is greater than a predetermined value, as the edge region, and the second input signal edge region extraction step may include steps of differentiating a signal value of the second input signal, and extracting a coordinate, at which the absolute value of the once differentiated value is greater than a predetermined value, as the edge region.

The first template edge region extraction step may include steps of: differentiating the signal value of the first template signal; detecting extremum points at which the once differentiated value takes an extremum; further differentiating the once differentiated value; and extracting a coordinates from a point at which the twice differentiated value takes a local minimum value to a point at which the twice differentiated value takes a local maximum value including the extremum points of the once differentiated value, as the edge region, the first input signal edge region extraction step may include steps of: differentiating the signal value of the first input signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region, the second template edge region extraction step may include steps of: differentiating the signal value of the second template signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region, and the second input signal edge region extraction step may include steps of: differentiating the signal value of the second input signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region.

The first axis/second section detection step may include a step of extracting an edge region where a level of the pixel value in the third input signal, changes a lot, so that the first axis/second section is detected based on the signal value of the edge region in the first template signal, and the signal value of the edge region in the third input signal.

The first template edge region extraction step may include steps of differentiating the signal value of the first template signal, and extracting a coordinate, at which the absolute value of the once differentiated value is greater than a predetermined value, as the edge region, and the third input signal edge region extraction step may include-steps of differentiating the signal value of the third input signal, and extracting a coordinate, at which the absolute value of the once differentiated value is greater than a predetermined value, as the edge region.

The first template edge region extraction step may include steps of: differentiating the signal value of the first template signal; detecting extremum points at which the once differentiated value takes an extremum; further differentiating the once differentiated value; and extracting coordinates from a point at which the twice differentiated value takes a local minimum value to a point at which the twice differentiated value takes a local maximum value including the extremum points of the once differentiated value, as the edge region, and the third input signal edge region extraction step may include steps of: differentiating the signal value of the third input signal; detecting extremum points at which the once differentiated value takes an extremum; further differentiating the once differentiated value; and extracting coordinates from a point at which the twice differentiated value takes a local minimum value to a point at which the twice differentiated value takes a local maximum value including the extremum points of the once differentiated value, as the edge region.

The first axis/first section detection step may include steps of: comparing the first template signal with the first input signal by scanning the first input signal for every range of a width of the template image in the direction of the first axis; and calculating a first correlation value indicating correlation between the first template signal and the first input signal, so that the first axis/first section is detected based on the first correlation value, and the second axis/first section detection step may include steps of: comparing the second template signal with the second input signal by scanning the second input signal for every range of a width of the template image in the direction of the second axis; and calculating a second correlation value indicating correlation between the second template signal and the second input signal, so that the second axis/first section is detected based on the second correlation value.

The first axis/first section detection step may detect a region including coordinates on the first axis, at which the first correlation value takes a local maximum value, as the first axis/first section, and the second axis/first section detection step may detect a region including coordinates on the second axis, at which the second correlation value takes a local maximum value, as the second axis/first section.

The first axis/first section detection step may detects a region including a coordinate, at which the local maximum value is greater than a predetermined threshold, among the coordinates at which the first correlation value takes the local maximum value, as the first axis/first section, and the second axis/first section detection step may detect a region including a coordinate, at which the local maximum value is greater than a predetermined threshold, among the coordinates at which the second correlation value takes the local maximum value, as the second axis/first section.

The first axis/second section detection step may include steps of: comparing the first template signal with the third input signal by scanning the third input signal for every range of a width of the template image in the direction of the first axis; and calculating a third correlation value indicating correlation between the first template signal and the third input signal, so that the first axis/second section is detected based on the third correlation value.

The first axis/second section detection step may include steps of: comparing the first template signal with the third input signal by scanning the third input signal for every range of a width of the template image in the direction of the first axis; and calculating a third correlation value indicating correlation between the first template signal and the third input signal, so that the first axis/second section is detected based on the third correlation value, and the second axis/second section detection step may include steps of: comparing the second template signal with the fourth input signal by scanning the fourth input signal for every range of a width of the template image in the direction of the second axis; and calculating a fourth correlation value indicating correlation between the second template signal and the fourth input signal, so that the second axis/second section is detected based on the fourth correlation value.

According to the second aspect of the present invention, there is provided an image matching apparatus for detecting an approximate region approximated to a predetermined template image from an input image. The image matching apparatus includes: input signal generating means for generating a first input signal and a second input signal representing a pixel value of the input image respectively projected on a first axis and a second axis substantially perpendicular to the first axis; first axis/first section detecting means for detecting a first axis/first section including a region corresponding to the approximate region in a direction of the first axis based on a first template signal representing a pixel value of the template image projected on the first axis, and also based on the first input signal; second axis/first section detecting means for detecting a second axis/first section including a region corresponding to the approximate region in a direction of the second axis based on a second template signal representing a pixel value of the template image projected on the second axis, and also based on the second input signal; candidate region signal generating means for generating a third input signal representing a pixel value of a candidate region image in the input image specified by the first axis/first section and the second axis/first section projected on the first axis; and first axis/second section detecting means for detecting a first axis/second section including a region corresponding to the approximate region in the direction of the first axis based on the first template signal and the third input signal.

The candidate region signal generating means may generate a fourth input signal representing a pixel value of the candidate region image projected on the second axis, and the image matching apparatus may further include second axis/second section detecting means for detecting a second axis/second section including a region corresponding to the approximate region in the direction of the second axis based on the second template signal and the fourth input signal.

The image matching apparatus may further include template signal generating means for generating the first template signal and the second template signal by respectively projecting the pixel value of the template image on the first axis and the second axis of the template image.

According to the third aspect of the present invention, there is provided a wafer processor for exposing a circuit pattern on a wafer. The wafer processor includes: input image acquiring means for acquiring an image including a mark provided on the wafer as an input image; storage means for storing a template image; template signal generating means for generating a first template signal and a second template signal representing the pixel value of the template image stored in the storage means, respectively projected on a first axis and a second axis of the image, the second axis being substantially perpendicular to the first axis; input signal generating means for generating a first input signal and a second input signal representing a pixel value of the input image respectively projected on the first axis and the second axis; first axis/first section detecting means for detecting a first axis/first section including a region corresponding to the template image in a direction of the first axis based on the first template signal and the first input signal; second axis/first section detecting means for detecting a second axis/first section including a region corresponding to the template image in a direction of the second axis based on the second template signal and the second input signal; candidate region signal generating means for generating a third input signal representing a pixel value of a candidate region image in the input image specified by the first axis/first section and the second axis/first section projected on the first axis; first axis/second section detecting means for detecting a first axis/second section including a region corresponding to the template image in the direction of the first axis based on the first template signal and the third input signal; matching means for matching a determined region image in the input image specified by the first axis/first section with the template image, so as to detect a position of the wafer based on the position of the mark on the wafer; and moving means for moving the wafer based on the detected position of the wafer.

The candidate region signal generating means may generate a fourth input signal representing a pixel value of the candidate region image projected on the second axis, and the wafer processor may further include second axis/second section detecting means for detecting a second axis/second section including a region corresponding to the approximate region in the direction of the second axis based on the second template signal and the fourth input signal.

The summary of the invention does not necessarily describe all necessary features of the present invention. The present invention may also be a sub-combination of the features described above.

### BRIEF DESCRIPTION OF THE DRAWINGS

FIG. 1 is a block diagram showing a wafer processor according to an embodiment of the present invention.

FIG. 2 is a flow chart showing each step of the wafer processor according to the present embodiment detecting an approximate region from an input image.

FIGS. 3A to 3D are schematic views showing a procedure for detecting a mark from the input image of the wafer using the wafer processor according to the embodiment of the present invention.

FIGS. 4A to 4C are schematic views showing a first template signal and a second template signal representing a template image respectively projected on a first axis and a second axis.

FIGS. 5A to 5F are charts showing steps of extracting an edge region from each signal.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

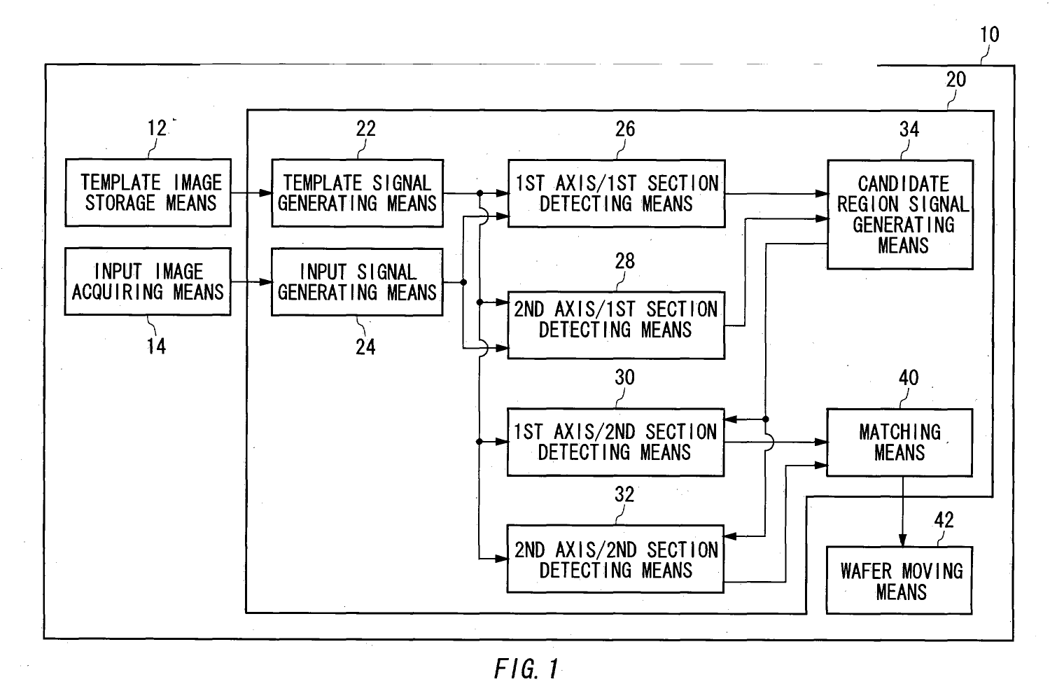

FIG. 1 is a block diagram exemplary showing a configuration of a wafer processor according to an embodiment of the present invention.

The wafer processor 10 exposes a circuit pattern on a wafer. The wafer processor 10 includes: input image acquiring means 14 for acquiring an image, which has a mark on the wafer, as an input image; template image storage means 12 for storing a template image; a matching apparatus 20 for detecting an approximate region approximated to a predetermined template image from the input image as the mark; matching means 40 for matching the detected mark with the template image and for detecting the position of the wafer based on the position of the mark on the wafer; and wafer moving means 42 for moving the wafer based on the detected position of the wafer. For example, the wafer processor 10 is a wafer aligner of an electron beam exposure apparatus or the like. In this case, the wafer processor 10 further includes an electron gun for generating an electron beam, an electron lens for focusing and adjusting a focal point of the electron beam, and a deflecting section for deflecting the electron beam.

The matching apparatus 20 includes template signal generating means 22, input signal generating means 24, first axis/first section detecting means 26, second axis/first section detecting means 28, first axis/second section detecting means 30, second axis/second section detecting means 32, candidate region signal generating means 34, and the matching means 40.

The template signal generating means 22 generates a first template signal and a second template signal representing a pixel value of the template image, which is stored in the template image storage means 12, respectively projected on a first axis and a second axis, which is different from the first axis. It is preferable that the second axis is substantially perpendicular to the first axis. The input signal generating means 24 generates a first input signal and a second input signal representing pixel values of the input image acquired by the input image acquiring means 14 respectively projected on the first axis and the second axis.

The first axis/first section detecting means 26 detects a first axis/first section including the approximate region in a direction of the first axis based on the first template signal and the first input signal. The first axis/first section detecting means 26 extracts an edge region where level of the pixel value in the first template signal changes a lot, and extracts an edge region where level of the pixel value in the first input signal changes a lot. In this case, it is preferable that the first axis/first section detecting means 26 detects the first axis/first section based on the signal value of the edge region in the first template signal and the signal value of the edge region in the first input signal.

The second axis/first section detecting means 28 detects a second axis/first section including the approximate region in a direction of the second axis based on the second template signal and the second input signal. The second axis/first section detecting means 28 extracts an edge region where level of the pixel value in the second template signal changes a lot, and extracts an edge region where level of the pixel value in the second input signal changes a lot. In this case, it is preferable that the second axis/first section detecting means 28 detects the second axis/first section based on the signal value of the edge region in the second template signal and the signal value of the edge region in the second input signal.

As for the wafer processor 10 according to the present embodiment, since the first axis/first section detecting means 26 and the second axis/first section detecting means 28 respectively detect the first axis/first section in the direction of the first axis and the second axis/first section in the direction of the second axis one dimensionally, a candidate region, where the approximate region is likely to be included, is determined rapidly.

Moreover, by the first axis/first section detecting means 26 and the second axis/first section respectively detecting the first axis/first section and the second axis/first section based on the signal value of the edge region, a mark in the input image is detected accurately, without being influenced by local variance of the image value of the input image due to a state of the wafer.

Next, an example of steps of the first axis/first section detecting means 26 and the second axis/first section detecting means 28 extracting the edge region will be explained.

The first axis/first section detecting means 26 differentiates the signal value of the first template signal, and extracts a coordinate, at which the absolute value of the once differentiated value is greater than a predetermined value, as the edge region in the first template signal. Next, the first axis/first section detecting means 26 differentiates the signal value of the first input signal, and extracts a coordinate, at which the absolute value of the once differentiated value is greater than a predetermined value, as the edge region.

Similarly, the second axis/first section detecting means 28 differentiates the signal value of the second template signal, and extracts a coordinate, at which the absolute value of the once differentiated value is greater than a predetermined value, as the edge region in the second template signal. Next, the second axis/first section detecting means 28 differentiates the signal value of the second input signal, and extracts a coordinate, at which the absolute value of the once differentiated value is greater than a predetermined value, as the edge region in the second input signal.

Next, another example of steps of the first axis/first section detecting means 26 and the second axis/first section detecting means 28 extracting the edge region will be explained.

The first axis/first section detecting means 26 differentiates the signal value of the first template signal and the first input signal respectively, and detects an extremum point at which the once differentiated value takes an extremum. Next, the first axis/first section detecting means 26 further differentiates the once differentiated value of the first template signal and the first input signal respectively, and extracts coordinates from a point at which the twice differentiated value takes a local minimum value to a point at which the twice differentiated value takes a local maximum value including the extremum points of the once differentiated value, as the edge region in each of the signal.

Similarly, the second axis/first section detecting means 28 differentiates the signal value of the second template signal and the second input signal respectively, and detects an extremum point at which the once differentiated value takes an extremum. Next, the second axis/first section detecting means 28 further differentiates the once differentiated value of the second template signal and the second input signal respectively, and extracts coordinates from a point at which the twice differentiated value takes a local minimum value to a point at which the twice differentiated value takes a local maximum value including the extremum points of the once differentiated value, as the edge region in each of the signal.

Since the first axis/first section detecting means 26 and the second axis/first section detecting means 28 extract the edge region, the wafer processor 10 according to the present embodiment determines the candidate region rapidly.

The candidate region signal generating means 34 generates a third input signal representing the pixel value of the candidate region image in the input image specified by the first axis/first section and the second axis/first section projected on the first axis. Alternatively, the candidate region signal generating means 34 further generate a fourth input signal representing the pixel value of the candidate region image projected on the second axis.

The first axis/second section detecting means 30 detects a first axis/second section including a region corresponding to the approximate region in the direction of the first axis based on the first template signal and the third input signal. The first axis/second section detecting means 30 extracts an edge region where level of the pixel value in the third input signal changes a lot. In this case, it is preferable that the first axis/second section detecting means 30 detects the first axis/second section based on the signal value of the edge region in the first template signal extracted by the first axis/first section detecting means 26 and the signal value of the edge region in the third input signal.

The second axis/second section detecting means 32 detects a second axis/second section including a region corresponding to the approximate region in a direction of the second axis based on the second template signal and the fourth input signal. The second axis/second section detecting means 32 extracts an edge region where level of the pixel value in the fourth input signal changes a lot. In this case, it is preferable that the second axis/second section detecting means 32 detects the second axis/second section based on the signal value of the edge region in the second template signal extracted by the second axis/first section detecting means 28 and the signal value of the edge region in the fourth input signal.

As for the wafer processor 10 according to the present embodiment, since the first axis/second section detecting means 30 and the second axis/second section detecting means 32 respectively detect the first axis/second section in the direction of the first axis and the second axis/second section in the direction of the second axis one dimensionally, the approximate region is rapidly determined from the candidate region. Moreover, since the image is matched only based on the pixel value of the candidate region, the mark is detected accurately.

Next, an example of steps of the first axis/second section detecting means 30 and the second axis/second section detecting means 32 extracting the edge region will be explained.

The first axis/second section detecting means 30 differentiates the signal value of the first template signal, and extracts a coordinate, at which the absolute value of the once differentiated value is greater than a predetermined value, as the edge region. Next, the first axis/second section detecting means 30 differentiates the signal value of the third input signal, and extracts a coordinate, at which the absolute value of the once differentiated value is greater than a predetermined value, as the edge region.

The second axis/second section detecting means 32 differentiates the signal value of the second template signal, and extracts a coordinate, at which the absolute value of the once differentiated value is greater than a predetermined value, as the edge region. Next, the second axis/second section detecting means 32 differentiates the signal value of the fourth input signal, and extracts a coordinate, at which the absolute value of the once differentiated value is greater than a predetermined value, as the edge region.

Next, another example of steps of the first axis/second section detecting means 30 and the second axis/second section detecting means 32 extracting the edge region will be explained.

The first, axis/second section detecting means 30 differentiates the signal value of the third input signal, and detects an extremum point at which the once differentiated value takes an extremum. Next, the first axis/second section detecting means 30 further differentiates the once differentiated value of the third input signal, and extracts coordinates from a point at which the twice differentiated value takes a local minimum value to a point at which the twice differentiated value takes a local maximum value including the extremum points of the once differentiated value, as the edge region.

The second axis/second section detecting means 32 differentiates the signal value of the fourth input signal, and detects an extremum point at which the once differentiated value takes an extremum. Next, the second axis/second section detecting means 32 further differentiates the once differentiated value of the fourth input signal, and extracts coordinates from a point at which the twice differentiated value takes a local minimum value to a point at which the twice differentiated value takes a local maximum value including the extremum points of the once differentiated value, as the edge region.

Since the first axis/second section detecting means 30 and the second axis/second section detecting means 32 extract the edge region, the wafer processor 10 according to the present embodiment determines the candidate region rapidly.

Alternatively, the matching means 40 further matches a determined region image in the input image specified by the first axis/second section and the second axis/second section, with the template image. The matching means 40 generates a fifth input signal and a sixth input signal representing the pixel value of the determined region image in the input image specified by the first axis/second section and the second axis/second section respectively projected on the first axis and the second axis.

The matching means 40 extracts a plurality of edge regions where the level of the pixel value in the fifth input signal changes a lot. Furthermore, the matching means 40 calculates the distance between the plurality of edge regions in the fifth input signal, and calculates combination of the edge regions where the calculated distance between the edge regions is within a tolerance. The matching means 40 extracts a plurality of edge regions where the level of the pixel value in the first template signal changes a lot. Furthermore, the matching means 40 calculates a distance between the plurality of edge regions in the first template signal, and calculates combination of the edge region where the calculated distance between the edge regions is within a tolerance.

The matching means 40 matches the determined region image with the template image by aligning the center of the combination of the edge regions in the fifth input signal with the center of the combination of the edge regions in the first template signal.

The matching means 40 extracts a plurality of edge regions where the level of the pixel value in the sixth input signal changes a lot. Furthermore, the matching means 40 calculates the distance between the plurality of edge regions in the sixth input signal, and calculates combination of the edge regions where the calculated distance between the edge regions is within a tolerance. The matching means 40 extracts a plurality of edge regions where the level of the pixel value in the second template signal changes a lot. Furthermore, the matching means 40 calculates a distance between the plurality of edge regions in the second template signal, and calculates combination of the edge region where the calculated distance between the edge regions is within a tolerance.

The matching means 40 matches the determined region image with the template image by aligning the center of the combination of the edge regions in the sixth input signal with the center of the combination of the edge regions in the second template signal.

Since the matching means 40 matches the determined region image and the template image by the above-described method, the wafer processor 10 according to the present embodiment detects the mark in the input image accurately regardless of acquiring condition of the template image and the input image.

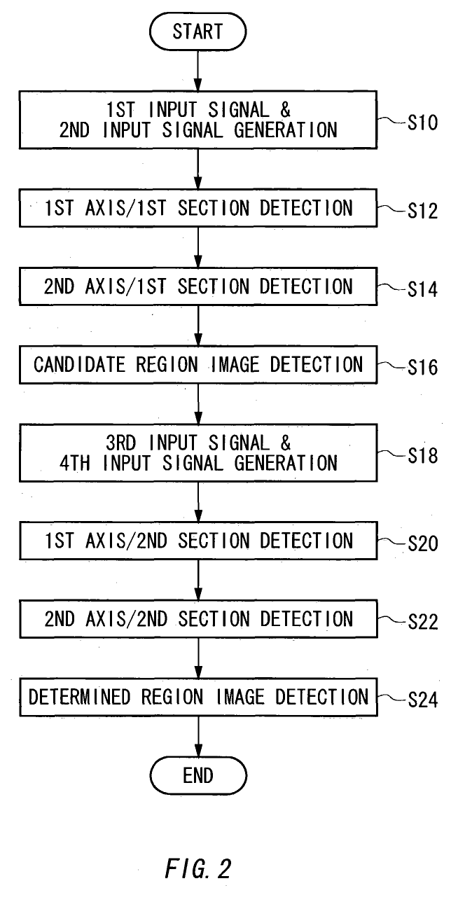

FIG. 2 is a flow chart showing each step of the wafer processor 10 according to the present embodiment detecting the approximate region from the input image.

In the present embodiment, the input signal generating means 24 generates the first input signal and the second input signal at first (S10). Next, the first axis/first section detecting means 26 and the second axis/first section detecting means 28 detect the first axis/first section and the second axis/first section respectively (S12, S14). Then, the candidate region signal generating means 34 detects the candidate region image specified by the first axis/first section and the second axis/first section (S16). Next, the candidate region signal generating means 34 generates the third input signal and the fourth input signal (S18). Next, the first axis/second section detecting means 30 and the second axis/second section detecting means 32 detect the first axis/second section and the second axis/second section respectively (S20, S22). Next, the matching means 40 detects the determined region image specified by the first axis/second section and the second axis/second section (S24).

Each of the steps will be explained hereinafter in detail in relation to drawings.

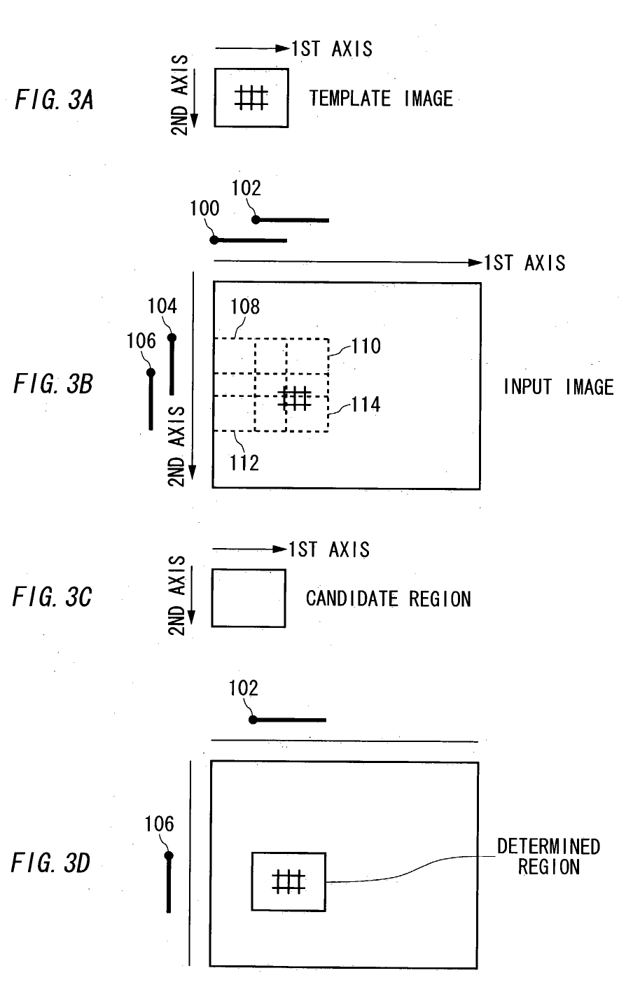

FIGS. 3A-3D are schematic views showing a procedure for detecting a mark from the input image of the wafer using the wafer processor according to the embodiment of the present invention.

FIG. 3A is a drawing showing a predetermined template image. The template image according to the present embodiment has a pattern of two lines being parallel with the first axis and three lines being parallel with the second axis. This pattern is constituted by a concavo-convex generated by etching on the wafer. In this case, the region of the pattern of the template image photographed by CCD (Charged Coupled Device) or the like has different contrast and different pixel value from the other region. Alternatively, the template image is a predetermined data stored in the template image storage means 12.

The template signal generating means 22 projects the pixel value of the template image on the first axis and the second axis respectively. In the first template signal and the second template signal projected on the first axis and the second axis, the pixel value of the region of the pattern of the template image is different from that of the other region. Therefore, the first template signal and the second template signal have the pattern reflecting the pattern of the template image respectively.

FIG. 3B is a drawing showing the input image acquired by the input image acquiring means 14. The input image according to the present embodiment includes a mark, which is the approximate region having substantially the same pattern as the template image. The mark included in the input image is constituted by concavo-convex formed by etching on the wafer. Therefore, contrast and also the pixel value of the marks of the input image photographed by the CCD or the like are different from those of the other region.

The input signal generating means 24 projects the pixel value of the input image on the first axis and the second axis respectively. In the first input signal and the second input signal projected on the first axis and the second axis, the pixel value of the region of the mark of the input image is different from that of the other region. Therefore, the first input signal and the second input signal have the pattern reflecting the pattern of the mark respectively.

The first axis/first section detecting means 26 scans the first template signal of the template image on the first input signal of the input image. Specifically, the first axis/first section detecting means 26 scans the first template signal on the first input signal for every range of a width of the template image in the direction of the first axis, and compares the first template signal with the first input signal. The first axis/first section detecting means 26 calculates a first correlation value indicating correlation between the first template signal and the first input signal, and detects the first axis/first section based on the first correlation value. The first axis/first section detecting means 26 detects the edge region from the first template signal and the first input signal respectively, and calculates the first correlation value based on the pixel value and the coordinate of each signal in the edge region.

The first correlation value is a normalized correlation value calculated based on following equations (1) to (3). In the present embodiment, the normalized correlation value is calculated using only the signal value of the coordinates of the edge region of the first template signal and the first input signal.

Equation (1) is an equation for calculating the signal value of the first template signal.

$${T}_{x} ( m ) = \frac{1}{N} {\sum }_{n = 1}^{N} T ( m , n ) \qquad ( 1 )$$

Where T(m,n) is a pixel value of the template image at a coordinate m in the direction of the first axis and a coordinate n in the direction of the second axis. N is the number of the pixels of the template image in the direction of the second axis. Tₓ(m) is a signal value of the first template signal at the coordinate n in the direction of the first axis. The coordinate of the edge region in the first template signal is detected from the signal value Tₓ(m).

Equation (2) is an equation for calculating the signal value of the first input signal.

$${X}_{x} ( i ) = \frac{1}{J} {\sum }_{j = 1}^{J} X ( i , j ) \qquad ( 2 )$$

Where X(i,j) is a pixel value of the input image at a coordinate i in the direction of the first axis and a coordinate j in the direction of the second axis. J is the number of the pixels of the input image in the direction of the second axis. Xₓ(i) is a signal value of the first input signal at the coordinate i in the direction of the first axis. The coordinate of the edge region in the first input signal is detected from the signal value Xₓ(i).

Equation (3) is an equation for calculating the normalized correlation value.

$$\begin{matrix}{γ}_{x} ( i ) = \frac{{\sum }_{m ∈ edgeX} ( {X}_{x} ( i + m - 1 ) - {X}_{x} ) ( {T}_{x} ( m ) - \overline{{T}_{x}} )}{\sqrt{{\sum }_{m ∈ edgeX} {( {X}_{x} ( i + m - 1 ) - \overline{{X}_{x}} )}^{2} {\sum }_{m ∈ edgeX} {( {T}_{x} ( m ) - \overline{{T}_{x}} )}^{2}}} \\ \overline{{X}_{x}} = \frac{1}{{M}^{′}} {\sum }_{m ∈ edgeX} X ( i + m - 1 ) , \overline{{T}_{x}} = \frac{1}{{M}^{′}} {\sum }_{m ∈ edgeX} {T}_{x} ( m )\end{matrix} \qquad ( 3 )$$

Where M′ is the number of the pixels in the edge region detected from the first template signal Tₓ(m). Moreover, “edgeX” is a set of the coordinate values in the detected edge region.

It is preferable that the first axis/first section detecting means 26 detects the coordinate on the first axis, at which the first correlation value takes a local maximum value, as the first axis/first section. Alternatively, the first axis/first section detecting means 26 detects a coordinate, at which the local maximum value is greater than a predetermined threshold, as the first axis/first section. Alternatively, the first axis/first section detecting means 26 detects coordinate, at which the first correlation value is greater than a predetermined threshold among coordinates in the vicinity of the coordinate having the local maximum value, as the first axis/first section. The first axis/first section detecting means 26 detects a plurality of coordinates as the first axis/first section. According to the present embodiment, the first axis/first section detecting means 26 detects two coordinates 100 and 102 as the first axis/first section.

The second axis/first section detecting means 28 scans the second template signal of the template image on the second input signal of the input image. Specifically, the second axis/first section detecting means 28 scans the second template signal on the second input signal for every range of a width of the template image in the direction of the second axis, and compares the second template signal with the second input signal. The second axis/first section detecting means 28 calculates a second correlation value indicating correlation between the second template signal and the second input signal, and detects the second axis/first section based on the second correlation value. The second axis/first section detecting means 28 detects the edge region from the second template signal and the second input signal respectively, and calculates the second correlation value based on the pixel value and the coordinate of each signal in the edge region.

As described above, the second correlation value is a normalized correlation value calculated based on similar equation to the first correlation value.

It is preferable that the second axis/first section detecting means 28 detects the coordinate on the second axis, at which the second correlation value takes a local maximum value, as the second axis/first section. Alternatively, the second axis/first section detecting means 28 detects a coordinate, at which the local maximum value is greater than a predetermined threshold, as the second axis/first section. Alternatively, the second axis/first section detecting means 28 detects coordinate, at which the second correlation value is greater than a predetermined threshold among coordinates in the vicinity of the coordinate having the local maximum value, as the second axis/first section. The second axis/first section detecting means 28 detects a plurality of coordinates as the second axis/first section. According to the present embodiment, the second axis/first section detecting means 28 detects two coordinates 104 and 106 as the second axis/first section.

As described above, the candidate region is determined from the first axis/first section detected by the first axis/first section detecting means 26 and the second axis/first section detected by the second axis/first section detecting means 28. The size of the candidate region is substantially the same as that of the template image. Alternatively, the candidate region is larger than the template image, and is smaller than the input image. In case that the first axis/first section detecting means 26 and the second axis/first section detecting means 28 detect the plurality of first axis/first sections and the second axis/first sections respectively, the candidate region signal generating means 34 selects a plurality of candidate regions determined by the plurality of first axis/first sections and the second axis/first sections respectively. In the present embodiment, the candidate region signal generating means 34 selects four candidate regions 108, 110, 112, and 114 determined by two first axis/first sections 100 and 102 and two second axis/first sections 104 and 106 detected by the first axis/first section detecting means 26 and the second axis/first section detecting means 28 respectively.

FIG. 3C is a drawing showing the candidate region specified by the first axis/first section and the second axis/first section.

The candidate region signal generating means 34 generates the third input signal and the fourth input signal representing the pixel value of the candidate region specified by the first axis/first section detecting means 26 and the second axis/first section detecting means 28 projected on the first axis and the second axis respectively. Alternatively, the candidate region signal generating means 34 generates either the third input signal or the fourth input signal. In the present embodiment, the candidate region signal generating means 34 generates the third input signal representing the pixel value of each of four candidate regions 108, 110, 112, and 114 projected on the first axis.

The first axis/second section detecting means 30 scans the first template signal on the third input signal for every range of a width of the template image in the direction of the first axis, and compares the first template signal with the third input signal. The first axis/second section detecting means 30 calculates a third correlation value indicating correlation between the first template signal and the third input signal, and detects the first axis/second section based on the third correlation value. The first axis/second section detecting means 30 detects the edge region from the first template signal and the third input signal respectively, and calculates the third correlation value based on the pixel value and the coordinate of each signal in the edge region. As described above, the third correlation value is a normalized correlation value calculated based on similar equation to the first correlation value.

It is preferable that the first axis/second section detecting means 30 detects the coordinates on the first axis, at which the third correlation value takes the maximum value, as the first axis/second section. In the present embodiment, the first axis/second section detection means 30 detects the coordinates corresponding to a third signal which provides the largest third correlation value among a plurality of third signals generated from each of the plurality of candidate regions 108, 110, 112, and 114 as the first axis/second section. In the present embodiment, it is determined that the third signal generated from the candidate region 114 provides the largest third correlation value. At this time, the first axis/second section detection means 30 detects the first axis/first section 102 as the first axis/second section.

In another example, the candidate region signal generating means 34 selects a region larger than the template image including the plurality of candidate regions 108, 110, 112, and 114, as the candidate region. In this case, the candidate region signal generating means 34 generates the third input signal and the fourth input signal representing the pixel value of the selected candidate region projected on the first axis and the second axis respectively. The first axis/second section detecting means 30 detects the first axis/second section in a similar manner as the method described above. In this case, it is preferable that the first axis/second section detection means 30 detects the coordinates on the first axis, at which the third correlation value takes the local maximum value, as the first axis/second section. It is preferable that the first axis/second section detecting means 30 detects the coordinate, at which the local maximum value is greater than a predetermined threshold among the coordinates at which the third correlation value takes the local maximum value, as the first axis/second section. In this embodiment, the first axis/second section detection means 30 detects the coordinates on the first axis, at which the third correlation value takes the maximum value, as the first axis/second section. In the present embodiment, it is determined that the first axis/second section detection means 30 detects a region corresponding to the first axis/first section 102, as the first axis/second section.

The second axis/second section detecting means 32 scans the second template signal on the fourth input signal for every range of a width of the template image in the direction of the second axis, and compares the second template signal with the fourth input signal. The second axis/second section detecting means 32 calculates a fourth correlation value indicating correlation between the second template signal and the fourth input signal, and detects the second axis/second section based on the fourth correlation value. The second axis/second section detecting means 32 detects the edge region from the second template signal and the fourth input signal respectively, and calculates the fourth correlation value based on the pixel value and the coordinate of each signal in the edge region. As described above, the fourth correlation value is a normalized correlation value calculated based on similar equation to the first correlation value.

It is preferable that the second axis/second section detection means 32 detects the coordinates on the second axis, at which the fourth correlation value takes a local maximum value, as the second axis/second section. It is preferable that the second axis/second section detecting means 32 detects the coordinate, at which the local maximum value is greater than a predetermined threshold among the coordinates at which the fourth correlation value takes the local maximum value, as the second axis/second section. In this embodiment, the second axis/second section detection means 32 detects the coordinates on the second axis, at which the fourth correlation value takes the maximum value, as the second axis/second section. In the present embodiment, it is determined that the second axis/second section detection means 32 detects a region corresponding to the second axis/first section 106, as the second axis/second section.

FIG. 3D is a drawing showing the determined region image specified from the first axis/second section and the second axis/second section in the input image.

The matching means 40 matches the determined region image with the template image.

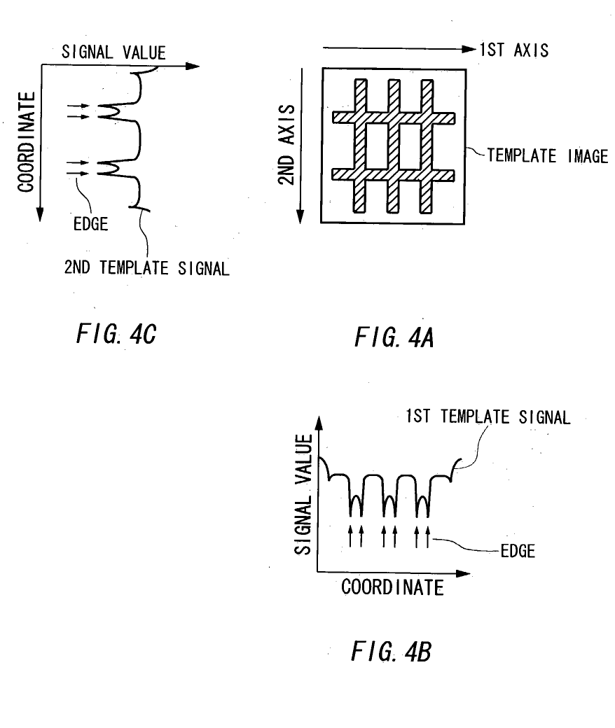

FIGS. 4A through 4C are schematic views showing the first template signal and the second template signal representing the template image respectively projected on the first axis and the second axis.

In FIG. 4A, a horizontal axis is the first axis and a vertical axis is the second axis. In another examples, the first axis and the second axes may be in any directions, e.g., a Y-axis is the first axis and an X-axis is the second axis.

FIG. 4B is a drawing showing relation between the coordinates in the direction of the first axis and the signal value of the first template signal. A pattern of the first template signal reflects the pattern of the template image. In the present embodiment, the template image includes a pattern of two lines being parallel with the first axis and three lines being parallel with the second axis. Therefore, the first template signal includes edges reflecting the three lines being parallel with the second axis.

FIG. 4C is a drawing showing relation between the coordinates in the direction of the second axis and the signal value of the second template signal. A pattern of the second template signal reflects the pattern of the template image. In the present embodiment, the second template signal includes edges reflecting the two lines being parallel with the first axis.

The first axis/first section detecting means 26 and the second axis/first section detecting means 28 detect the first axis/first section and the second axis/first section based on the coordinates of the edge region and the signal value of the first template signal and the second template signal corresponding to the coordinates.

It is preferable that the edge regions of the first input signal, the second input signal, the third input signal, the fourth input signal, the fifth input signal, and the sixth input signal are also detected by the same method as described above.

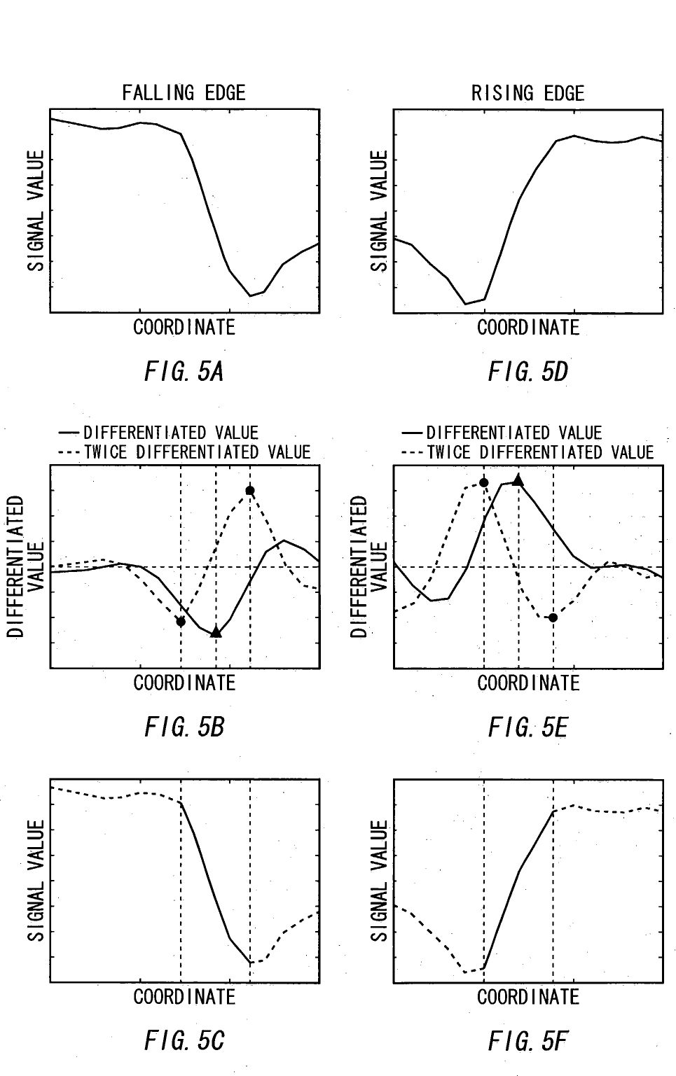

FIGS. 5A through 5F are charts showing steps of extracting the edge region from each signal.

FIGS. 5A to 5C is drawings showing steps of detecting a falling edge. FIG. 5A shows the signal value to the coordinates of the first template signal.

The first axis/first section detecting means 26 calculates a once differentiated value by differentiating the first template signal. Next, the first axis/first section detecting means 26 calculates a twice differentiated value by further differentiating the once differentiated value of the first template signal. FIG. 5B shows the once differentiated value and the twice differentiated value to the coordinates of the first template signal. The first axis/first section detecting means 26 detects the extremum point at which the once differentiated value takes a local minimum value. As shown in FIG. 5C, the first axis/first section detecting means 26 extracts the coordinates from a point at which the twice differentiated value takes a local minimum value to a point at which the twice differentiated value takes a local maximum value sandwiching the extremum points of the once differentiated value, as the falling edge of the first template signal.

FIGS. 5D to 5F is drawings showing steps of detecting a rising edge. FIG. 5D shows the signal value to the coordinates of the first template signal.

The first axis/first section detecting means 26 calculates a once differentiated value by differentiating the first template signal. Next, the first axis/first section detecting means 26 calculates a twice differentiated value by further differentiating the once differentiated value of the first template signal. FIG. 5E shows the once differentiated value and the twice differentiated value to the coordinates of the first template signal. The first axis/first section detecting means 26 detects the extremum point at which the once differentiated value takes a local maximum value. As shown in FIG. 5F, the first axis/first section detecting means 26 extracts the coordinates from a point at which the twice differentiated value takes a local maximum value to a point at which the twice differentiated value takes a local minimum value sandwiching the extremum points of the once differentiated value, as the rising edge of the first template signal.

In another example, the first axis/first section detecting means 26 extracts an edge region where level of the pixel value in the first input signal changes a lot. Moreover, the first axis/first section detecting means 26 calculates the distance between the plurality of edge regions in the first input signal, and calculates combination of the edge regions where the calculated distance between the edge regions is within a tolerance. The first axis/first section detecting means 26 extracts an edge region where level of the pixel value in the first template signal changes a lot. Moreover, the first axis/first section detecting means 26 calculates the distance between the plurality of edge regions in the first template signal, and calculates combination of the edge regions where the calculated distance between the edge regions is within a tolerance. The first axis/first section detecting means 26 detects the first axis/first section by aligning the center of the combination of the edge regions in the first input signal with the center of the combination of the edge regions in the first template signal. Moreover, the second axis/first section detecting means 28 extracts an edge region where level of the pixel value in the second input signal changes a lot. Moreover, the second axis/first section detecting means 28 calculates the distance between the plurality of edge regions in the second input signal, and calculates combination of the edge regions where the calculated distance between the edge regions is within a tolerance. The second axis/first section detecting means 28 extracts an edge region where level of the pixel value in the second template signal changes a lot, calculates the distance between the plurality of edge regions in the second template signal, and calculates combination of the edge regions where the calculated distance between the edge regions is within a tolerance.

The second axis/first section is detected by aligning the center of the combination of the edge regions in the second input signal with the center of the combination of the edge regions in the second template signal. The first axis/second section detecting means 30 and the second axis/second section detecting means 32 also detect the first axis/second section and the second axis/second section respectively by the same processing as that of the first axis/first section detecting means 26 and the second axis/first section detecting means 28.

Since the wafer processor 10 according to the present embodiment detects the first axis/first section and the second axis/first section from the input image one dimensionally, it rapidly determines the candidate region, where the approximate region is likely to be included.

Furthermore, since the wafer processor 10 according to the present embodiment specifies the approximate region by detecting the first axis/second section from the candidate region, it performs the image matching rapidly.

Moreover, the wafer processor 10 according to the present embodiment detects the mark in the input image accurately by detecting the candidate region and the approximate region based on the signal value of the edge region, without being influenced by the local variance of the image value of the input image due to the state of the wafer.

Furthermore, since the wafer processor 10 according to the present embodiment specifies the approximate region from the candidate region after detecting the candidate region, where the approximate region is likely to be included, from the input image, it detects the mark in the input image efficiently and accurately.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

As described above, according to the present invention, image matching can be performed rapidly.

What is claimed is:

1. An image matching method of detecting an approximate region approximated to a predetermined template image from an input image, comprising steps of:
generating a first input signal and a second input signal representing a pixel value of the input image respectively projected on a first axis and a second axis substantially perpendicular to the first axis;
detecting a first axis/first section including a region corresponding to the approximate region in a direction of the first axis based on a first template signal representing a pixel value of the template image projected on the first axis, and also based on the first input signal;
detecting a second axis/first section including a region corresponding to the approximate region in the direction of the second axis based on a second template signal representing a pixel value of the template image projected on the second axis, and also based on the second input signal;
generating a third input signal representing a pixel value of a candidate region image in the input image specified by the first axis/first section and the second axis/first section projected on the first axis; and
detecting a first axis/second section including a region corresponding to the approximate region in the direction of the first axis based on the first template signal and the third input signal.

2. The image matching method as claimed in claim 1, wherein,
said candidate region signal generating step comprises a step of generating a fourth input signal representing a pixel value of the candidate region image projected on the second axis, and
the image matching method further comprises a step of detecting a second axis/second section including a region corresponding to the approximate region in the direction of the second axis based on the second template signal and the fourth input signal.

3. The image matching method as claimed in claim 1, further comprising a step of generating the first template signal and the second template signal by respectively projecting the pixel value of the template image on the first axis and the second axis of the template image.

4. The image matching method as claimed in claim 1, wherein
said first axis/first section detection step comprises steps of: extracting an edge region where a level of the pixel value in the first template signal changes a lot; and extracting an edge region where the level of the pixel value in the first input signal changes a lot, and said first axis/first section detection step detects the first axis/first section based on the signal value of the edge region in the first template signal, and the signal value of the edge region in the first input signal, and
said second axis/first section detection step comprises steps of: extracting an edge region where a level of the pixel value in the second template signal changes a lot; and extracting an edge region where the level of the pixel value in the second input signal changes a lot, and said second axis/first section detection step detects the second axis/first section based on the signal value of the edge region in the second template signal, and the signal value of the edge region in the second input signal.

5. The image matching method as claimed in claim 4, wherein
said first template edge region extraction step comprises steps of differentiating a signal value of the first template signal, and extracting a coordinate, at which the absolute value of the once differentiated value is greater than a predetermined value, as the edge region,
said first input signal edge region extraction step comprises steps of differentiating a signal value of the first input signal, and extracting a coordinate, at which the absolute value of the once differentiated value is greater than a predetermined value, as the edge region,
said second template edge region extraction step comprises steps of differentiating a signal value of the second template signal, and extracting a coordinate, at which the absolute value of the once differentiated value is greater than a predetermined value, as the edge region, and
said second input signal edge region extraction step comprises steps of differentiating a signal value of the second input signal, and extracting a coordinate, at which the absolute value of the once differentiated value is greater than a predetermined value, as the edge region.

6. The image matching method as claimed in claim 4, wherein
said first template edge region extraction step comprises steps of: differentiating the signal value of the first template signal; detecting extremum points at which the once differentiated value takes an extremum; further differentiating the once differentiated value; and extracting a coordinates from a point at which the twice differentiated value takes a local minimum value to a point at which the twice differentiated value takes a local maximum value including the extremum points of the once differentiated value, as the edge region,
said first input signal edge region extraction step comprises steps of: differentiating the signal value of the first input signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region,
said second template edge region extraction step comprises steps of: differentiating the signal value of the second template signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region, and
said second input signal edge region extraction step comprises steps of: differentiating the signal value of the second input signal; detecting extremum points at which the once differentiated value takes an extremum; further differentiating the once differentiated value; and extracting coordinates from a point at which the twice differentiated value takes the minimum value to a point at which the twice differentiated value takes the maximum value including the extremum points of the once differentiated value, as the edge region.

7. The image matching method as claimed in claim 1, wherein
said first axis/second section detection step comprises a step of extracting an edge region where a level of the pixel value in the third input signal changes a lot, so that the first axis/second section is detected based on the signal value of the edge region in the first template signal, and the signal value of the edge region in the third input signal.

8. The image matching method as claimed in claim 7, wherein
said first template edge region extraction step comprises steps of differentiating the signal value of the first template signal, and extracting a coordinate, at which the absolute value of the once differentiated value is greater than a predetermined value, as the edge region, and
said third input signal edge region extraction step comprises steps of differentiating the signal value of the third input signal, and extracting a coordinate, at which the absolute value of the once differentiated value is greater than a predetermined value, as the edge region.

9. The image matching method as claimed in claim 7, wherein
said first template edge region extraction step comprises steps of: differentiating the signal value of the first template signal; detecting extremum points at which the once differentiated value takes an extremum; further differentiating the once differentiated value; and extracting coordinates from a point at which the twice differentiated value takes a local minimum value to a point at which the twice differentiated value takes a local maximum value including the extremum points of the once differentiated value, as the edge region, and
said third input signal edge region extraction step comprises steps of: differentiating the signal value of the third input signal; detecting extremum points at which the once differentiated value takes an extremum; further differentiating the once differentiated value; and extracting coordinates from a point at which the twice differentiated value takes a local minimum value to a point at which the twice differentiated value takes a local maximum value including the extremum points of the once differentiated value, as the edge region.

10. The image matching method as claimed in claim 1, wherein
said first axis/first section detection step comprises steps of: comparing the first template signal with the first input signal by scanning the first input signal for every range of a width of the template image in the direction of the first axis; and calculating a first correlation value indicating correlation between the first template signal and the first input signal, so that the first axis/first section is detected based on the first correlation value, and
said second axis/first section detection step comprises steps of: comparing the second template signal with the second input signal by scanning the second input signal for every range of a width of the template image in the direction of the second axis; and calculating a second correlation value indicating correlation between the second template signal and the second input signal, so that the second axis/first section is detected based on the second correlation value.

11. The image matching method as claimed in claim 10, wherein
said first axis/first section detection step detects a region including coordinates on the first axis, at which the first correlation value takes a local maximum value, as the first axis/first section, and
said second axis/first section detection step detects a region including coordinates on the second axis, at which the second correlation value takes a local maximum value, as the second axis/first section.

12. The image matching method as claimed in claim 10, wherein
said first axis/first section detection step detects a region including a coordinate, at which the local maximum value is greater than a predetermined threshold, among the coordinates at which the first correlation value takes the local maximum value, as the first axis/first section, and
said second axis/first section detection step detects a region including a coordinate, at which the local maximum value is greater than a predetermined threshold, among the coordinates at which the second correlation value takes the local maximum value, as the second axis/first section.

13. The image matching method as claimed in claim 1, wherein
said first axis/second section detection step comprises steps of: comparing the first template signal with the third input signal by scanning the third input signal for every range of a width of the template image in the direction of the first axis; and calculating a third correlation value indicating correlation between the first template signal and the third input signal, so that the first axis/second section is detected based on the third correlation value.

14. The image matching method as claimed in claim 2, wherein
said first axis/second section detection step comprises steps of: comparing the first template signal with the third input signal by scanning the third input signal for every range of a width of the template image in the direction of the first axis; and calculating a third correlation value indicating correlation between the first template signal and the third input signal, so that the first axis/second section is detected based on the third correlation value, and
said second axis/second section detection step comprises steps of: comparing the second template signal with the fourth input signal by scanning the fourth input signal for every range of a width of the template image in the direction of the second axis; and calculating a fourth correlation value indicating correlation between the second template signal and the fourth input signal, so that the second axis/second section is detected based on the fourth correlation value.

15. An image matching apparatus for detecting an approximate region approximated to a predetermined template image from an input image, comprising:
input signal generating means for generating a first input signal and a second input signal representing a pixel value of the input image respectively projected on a first axis and a second axis substantially perpendicular to the first axis;
first axis/first section detecting means for detecting a first axis/first section including a region corresponding to the approximate region in a direction of the first axis based on a first template signal representing a pixel value of the template image projected on the first axis, and also based on the first input signal;
second axis/first section detecting means for detecting a second axis/first section including a region corresponding to the approximate region in a direction of the second axis based on a second template signal representing a pixel value of the template image projected on the second axis, and also based on the second input signal;
candidate region signal generating means for generating a third input signal representing a pixel value of a candidate region image in the input image specified by the first axis/first section and the second axis/first section projected on the first axis; and
first axis/second section detecting means for detecting a first axis/second section including a region corresponding to the approximate region in the direction of the first axis based on the first template signal and the third input signal.

16. The image matching apparatus as claimed in claim 15, wherein
said candidate region signal generating means generates a fourth input signal representing a pixel value of the candidate region image projected on the second axis, and
the image matching apparatus further comprises second axis/second section detecting means for detecting a second axis/second section including a region corresponding to the approximate region in the direction of the second axis based on the second template signal and the fourth input signal.

17. The image matching apparatus as claimed in claim 15, further comprising template signal generating means for generating the first template signal and the second template signal by respectively projecting the pixel value of the template image on the first axis and the second axis of the template image.

18. A wafer processor for exposing a circuit pattern on a wafer, comprising:
input image acquiring means for acquiring an image including a mark provided on the wafer as an input image;
storage means for storing a template image;
template signal generating means for generating a first template signal and a second template signal representing the pixel value of the template image stored in said storage means, respectively projected on a first axis and a second axis of the image, the second axis being substantially perpendicular to the first axis;
input signal generating means for generating a first input signal and a second input signal representing a pixel value of the input image respectively projected on the first axis and the second axis;
first axis/first section detecting means for detecting a first axis/first section including a region corresponding to the template image in a direction of the first axis based on the first template signal and the first input signal;
second axis/first section detecting means for detecting a second axis/first section including a region corresponding to the template image in a direction of the second axis based on the second template signal and the second input signal;
candidate region signal generating means for generating a third input signal representing a pixel value of a candidate region image in the input image specified by the first axis/first section and the second axis/first section projected on the first axis;
first axis/second section detecting means for detecting a first axis/second section including a region corresponding to the template image in the direction of the first axis based on the first template signal and the third input signal;
matching means for matching a determined region image in the input image specified by the first axis/first section with the template image, so as to detect a position of the wafer based on the position of the mark on the wafer; and
moving means for moving the wafer based on the detected position of the wafer.

19. The wafer processor as claimed in claim 18, wherein
said candidate region signal generating means generates a fourth input signal representing a pixel value of the candidate region image projected on the second axis, and
the wafer processor further comprises second axis/second section detecting means for detecting a second axis/second section including a region corresponding to the approximate region in the direction of the second axis based on the second template signal and the fourth input signal.
